(19) United States
(12) Patent Application Publication
(10) Pub. No.: US 2004/0217058 A1
(43) Pub. Date: Nov. 4, 2004

(54) Integrated dissolved air flotation and immersed membrane filtration apparatus and method for using same

(76) Inventors: Jason Cadera, Guelph (CA); Nicholas Adams, Hamilton (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/734,212

(22) Filed: Dec. 15, 2003

Related U.S. Application Data
(60) Provisional application No. 60/434,396, filed on Dec. 19, 2002.

(51) Int. Cl. B01D 61/00

(52) U.S. Cl. 210/649; 210/650; 210/321.6

(57) ABSTRACT

An apparatus for treating water has a contact zone, a separation zone and a collection zone. The contact zone and the separation zone are located adjacent to each other in a tank. Feed water containing pressurized dissolved air enters and releases bubbles into the separation zone. The bubbles contact the contaminants to form bubble-contaminant complexes that float upwards and spread over the surface of the tank. Bubble-contaminant complexes move to the collection zone. A filtered permeate is withdrawn from the water in the tank through an immersed membrane filtration module located within the separation zone of the tank.

This is an application claiming the benefit under 35 USC 119(e) of U.S. application Ser. No. 60/434,396; filed Dec. 19, 2002. The disclosure of U.S. application Ser. No. 60/434,396 is incorporated herein by this reference to it.

### FIELD OF THE INVENTION

The present invention relates to water treatment, and more particularly to filtering water to provide water with reduced concentrations of particles or other contaminants, to dissolved air flotation and to immersed membrane filtration.

### BACKGROUND OF THE INVENTION

Raw water contains contaminants including suspended, colloidal and dissolved particles. Membrane filtration systems have been used with a pretreatment stage located upstream of a membrane filtration stage to reduce the amount of contaminants reaching the membranes. For example, clarifiers have been used to remove easily settled solids upstream of a membrane filter. Dissolved air filtration systems have been used as a pretreatment stage upstream of a media filter.

### SUMMARY OF THE INVENTION

It is an object of the present invention or inventions to improve on the prior art. Other objects of the invention or inventions include providing a water treatment process or apparatus. The one or more inventions may consist of combinations of one or more of the elements or steps described in this document. The summary below discusses various features that may help the reader understand the one or more inventions, but is not intended to define any invention.

The inventors have noticed that pretreatment stages may beneficially reduce the rate of fouling of a downstream filter, but that each additional stage tends to increase capital cost and plant space. Each additional stage can also add to the complexity of the system. In the present invention, however, dissolved air flotation is combined with an immersed membrane filter. The dissolved air floatation removes various contaminants such as colloids which tend to foul membranes rapidly. The dissolved air flotation stage and membrane filtration stage are integrated together to provide a reduction in capital cost and plant space compared to a system having two distinct stages. In particular, the membrane filters are located inside of the separation zone of a dissolved air flotation stage. The membranes are located towards the bottom of the separation zone below the area where bubbles aggregate at or near the surface of the separation zone. Effluent from the integrated system is withdrawn as permeate through the membranes. Although the membranes are located within the separation zone, they nevertheless operate in an area of reduced concentrations of contaminants. Operating in this area, membrane fouling is reduced.

In some aspects, the invention provides an apparatus for treating water having a contact zone, a separation zone and a collection zone. The separation zone further has an aggregation zone at or near the surface of the separation zone and a filtration zone directly below the aggregation zone. An inlet port is provided near the bottom of the contact zone for receiving a feed water containing pressurized dissolved air or otherwise pre-treated for a dissolved air filtration process. A pathway adapted to convey floating bubbles connects the top of the contact zone to the aggregation zone of the separation zone. A removal device, for example a skimmer, is operatively connected between the aggregation zone and the collection zone to move objects floating in the aggregation zone to the collection zone. An immersed suction-driven membrane filtration device is located in the filtration zone for withdrawing a filtered permeate from the filtration zone. The apparatus is adapted to perform dissolved air flotation and membrane filtration processes generally continuously and simultaneously.

In other aspects, the invention provides a method of treating water, for example to remove colloids or other contaminants to provide water with reduced concentrations of contaminants. Feed water containing pressurized dissolved air, or otherwise pre-treated as for a dissolved air flotation process, flows into a contact zone. Bubbles are released into and rise through the contact zone and contact contaminants to form bubble-contaminant complexes. The bubble-contaminant complexes move from the contact zone to a separation zone. The bubble-contaminant complexes aggregate at or near the surface of the separation zone. The aggregated bubble-contaminant complexes are removed from the separation zone. A filtered permeate is withdrawn from an area of the separation zone below where the bubble-contaminant complexes are aggregated through an immersed membrane filtration module. These steps may be performed generally continuously and generally simultaneously. Solids retained in the contact zone or separation zone may be removed from time to time or, optionally, generally continuously.

### BRIEF DESCRIPTION OF THE DRAWINGS

For a better understanding of the present invention, and to show more clearly how it may be carried into effect, reference will now be made, by way of example, to the accompanying drawings, which show exemplary embodiments of the present invention and in which:

FIG. 1 is a schematic diagram of an integrated dissolved air flotation and immersed membrane filtration apparatus according to a first embodiment of the present invention.

FIG. 2 is a schematic diagram of an integrated dissolved air flotation and immersed membrane filtration apparatus according to a second embodiment of the present invention.

FIG. 3 is a schematic diagram of a water treatment system incorporating the integrated dissolved air flotation and immersed membrane filtration apparatus of FIG. 1.

### DETAILED DESCRIPTION OF THE EMBODIMENTS

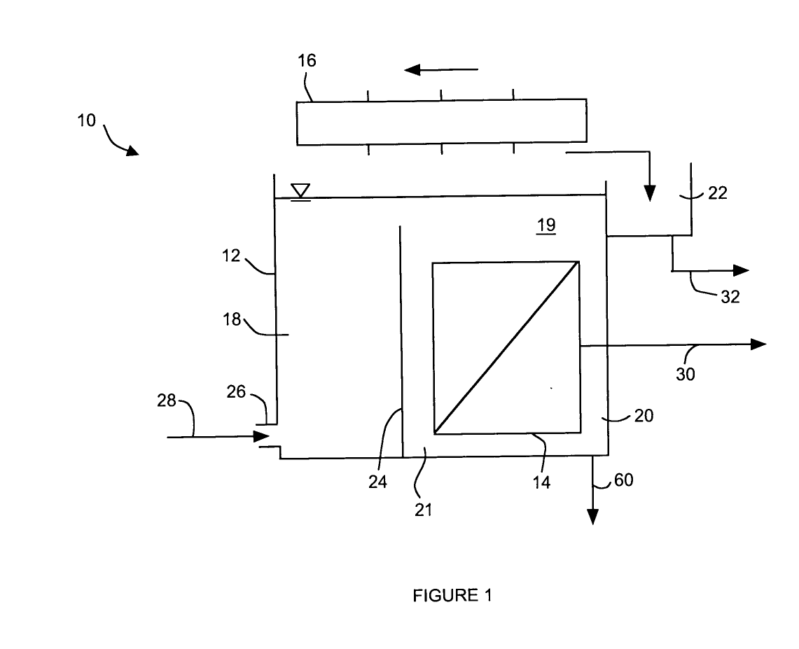

Referring first to FIG. 1, an integrated dissolved air flotation and immersed membrane filtration apparatus, or reactor, according to a first embodiment of the present invention is shown generally at 10. The reactor 10 has a tank 12 that is open to the atmosphere, filtration means 14 and, optionally, a skimmer 16.

The tank 12 has three zones, including a contact zone 18, a separation zone 20, and a collection zone 22. The separation zone 20 further has an aggregation zone 19 above a filtration zone 21. The contact zone 18 and the separation zone 20 may be at least partially separated by a separating means, for example, a divider 24 that extend part of the way to the top of the tank 12 and leaving a path between the top of the contact zone 18 and the aggregation zone 19. The tank 12 has an inlet port 26 that is fluidly connected to a feed water line 28. The inlet port 26 may be located near the bottom of the contact zone 18.

The filtration means 14 may be an immersed suction driven membrane module. The filtration means 14 is located in the filtration zone 21. The filtration means 14 may have pores that are sized for ultra-filtration or micro-filtration. For example an immersed hollow fiber membrane such as those sold under the trade mark ZEEWEED™ by Zenon Environmental Inc., such as ZW500 or ZW1000 modules, may be used. ZW 500 modules may be aerated intermittently to inhibit their fouling with minimal disturbance to the aggregation zone 19. ZW 1000 modules may also be aerated intermittently or used without aeration. Suitable modules are also described in Canadian Patent No. 2,227,692 which is fully incorporated herein by this reference to it. Permeate (filtered water) is removed from the filtration means 14 through permeate line 30 which may be connected to a permeate pump, gravity outflow, a siphon or other source of suction.

Still referring to FIG. 1, the reactor 10 is adapted to generally simultaneously and generally continuously perform dissolved air flotation and membrane filtration processes. For the dissolved air flotation process, feed water is introduced into the contact zone 18 of tank 12 through inlet port 26. Coagulation chemicals and pressurized dissolved air are both added to the feed water upstream of the inlet port 26. As the untreated feed water flows through the inlet port 26, tiny air bubbles are produced in vast quantities in the contact zone 18. In the contact zone 18, at least a portion of the bubbles contact and adhere to at least a portion of the contaminants in the feed water to form bubble-contaminant complexes. The bubble-contaminant complexes flow across to the aggregation zone 19 of the separation zone 20. The aggregation zone 19 has relatively quiescent conditions that allow the bubble-contaminant complexes to aggregate at the surface of the tank 12 where they dewater and form a float blanket. The optional skimmer 16, or another removal means or device, collects the bubble-contaminant complexes from the surface of the tank 12, and moves them into the solids collection zone 22. One alternative means in place of the skimmer 16 is a weir or lowered edge of the tank 12 between the aggregation zone 19 and collection zone 22 that allows bubble-contaminant complexes to overflow into the collection zone 22. In this case, bubble-contaminant complexes may be made to overflow generally continuously, by having a sufficient feed rate compared to flow rates out of the tank 12, or from time to time when the filtration means 14 is backwashed. Waste is removed from the collection zone, for example through a waste outlet 32.

For the membrane filtration process, suction on the inner surface of the filtration means 14 draws filtered permeate through the membrane wall. Permeate is removed from the filtration means 14 through permeate line 30. Contaminants not removed to the collection zone 22 are rejected by the filtration means 14 and accumulate in the separation zone 20. These accumulated contaminants can be removed from time to time by pumping them out or by wholly or partially draining the separation zone 20 through a retentate drain 60. Optionally, accumulated contaminants can be removed through the retentate drain without draining the separation zone 20, or with draining of the separation zone 20 to a lesser degree, by generally simultaneously increasing the supply of feed water or backwashing the filtration means 14. The filtration means 14 may be backwashed from time to time to dislodge contaminants and may be removed through a retentate drain 60 or pumped out from time to time.

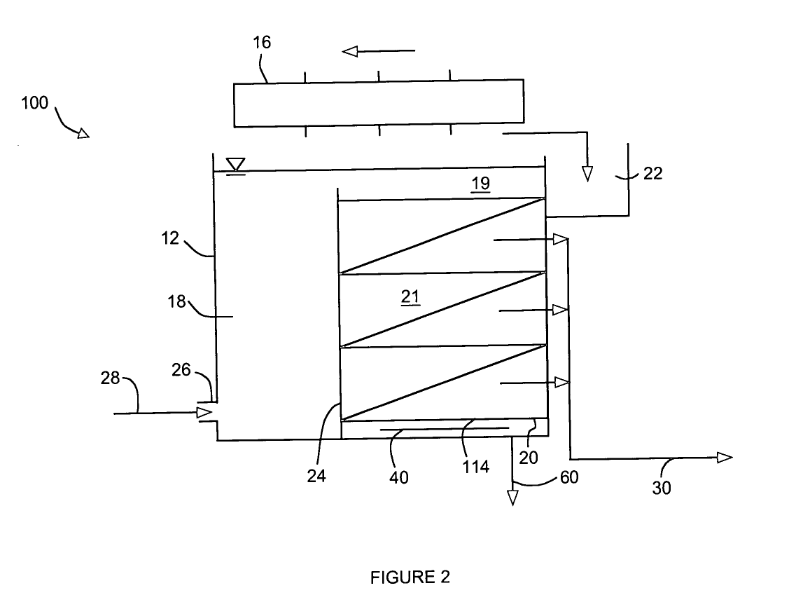

Referring now to FIG. 2, another integrated dissolved air flotation and immersed membrane filtration apparatus, or second reactor, is shown generally at 100. The second reactor 100 is similar to the reactor 10 but with the modifications as described below. A second filtration means 114 comprises one or more membrane modules that substantially cover the cross sectional area of the separation zone 20. Suitable modules are shown and described in PCT Publication No. WO 01/36075 which is fully incorporated herein by this reference to it. An aerator 40 is operated only periodically either during or directly before or after the second filtration means 114 is backwashed. In a manner similar to that described in WO 01/36075, the backwashing and aeration cause an air lift and increase in water level in the separation zone 20 which entrains contaminants retained in the filtration zone 21 and overflows then into the collection zone 22. More persistent contaminants, if any, may also be pumped out from time to time or removed through the retentate drain 60.

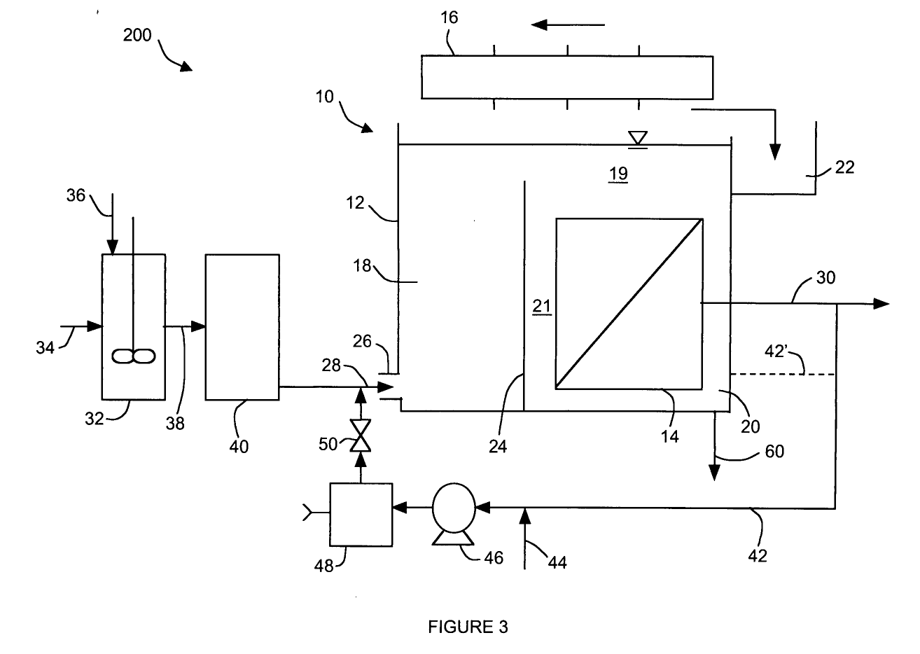

Referring now to FIG. 3, a water treatment system is generally shown at 200 incorporating the reactor 10 of FIG. 1. As in a conventional dissolved air flotation process, coagulation chemicals are added to the untreated feed water upstream of the module 10. Generally, two conditions are desirable to enhance flotation: (1) charge neutralization of the contaminants; and (2) production of hydrophobic contaminants. Adding one or more positively charged coagulation chemicals, such as polyaluminum chloride, tends to produce these conditions. The pH of the feed water may also be adjusted. Desired coagulant and pH conditions can be predicted by jar tests.

Untreated feed water is introduced into a static mixer 32 through line 34. Coagulant is added to the static mixer 32 through line 36. The water is thoroughly mixed to ensure rapid dispersion of the coagulant. Optionally, a coagulation aid may also be added to the static mixer 32 through line 36. The negatively charged suspended and colloidal contaminants are substantially neutralized in the static mixer 32. Optionally, an acid or alkali may also be added to the static mixer 32 through line 36 to maintain the pH at a desired level.

The water is withdrawn from the static mixer 32 through line 38, and enters a flocculation tank 40. The water in the flocculation tank 40 is gently mixed to promote particle collisions, resulting in the formation and growth of flocs. Large flocs are not needed for flotation, since the bubble-contaminant complexes require a density that is less than water to be able to rise to the surface of the tank 12. Accordingly, in known manner, the residence time in the flocculation tank 40 is chosen to produce flocs of a size so they can be efficiently removed by the dissolved air flotation process.

The water is withdrawn from the flocculation tank 40 through line 28, and is introduced into the contact zone 18 of tank 12 through inlet port 26. A percentage of permeate is recycled back to the inlet port 26 through line 42. Optionally, unfiltered water from the filtration zone 21 may be recycled back to the inlet port through line 42′. Air under pressure is injected through line 44 into the recycled permeate. The recycled permeate is then passed through a pressurization pump 46. The pressurization pump 46 sends the permeate to an air saturation tank 48, where the permeate is saturated with air taken from the atmosphere and pressurize to high pressures (i.e., about 60 psi to about 100 psi). A needle valve 50 in a line between the saturation tank 48 and the line 28 may be used to control the flow rate of the recycled permeate. A sudden drop in pressure after the needle valve 50 causes the formation of fine air bubbles ranging from about 1 μm to about 100 μm in size as the recycled permeate is mixed with the untreated feed water and passed into the reactor 10. Saturators, spargers or other means known in the art may also be used to produce the fine bubbles.

It is to be understood that what has been described are preferred embodiments of the invention for example and without limitation to the combination of features necessary for carrying the invention into effect. The invention may be susceptible to certain changes and alternative embodiments without departing from the subject invention, the scope of which is defined in the following claims. In particular, but without limitation, alternatives for numerous aspects of the DAF system or process described as occurring outside of the tank 12 in FIG. 3 are known in the art and may be used with the present invention. Also, the configuration of the tank 12 may be modified and the various zones 18 to 22 may be distributed across multiple tanks or vessels.

We claim:

1. An apparatus for treating water comprised of contaminants comprising:
(a) a contact zone;
(b) a separation zone having an aggregation zone above a filtration zone;
(c) a collection zone;
(d) an inlet port for receiving a feed of water into the contact zone;
(e) a passage between the top of the contact zone and the aggregation zone;
(f) a removal device adapted to move particles from the aggregation zone to the collection zone; and
(g) an immersed membrane filtration device located within the separation zone of the tank for withdrawing a filtered permeate.

2. A method of treating water having contaminants, the method comprising the steps of:
(a) introducing a feed of water to the inlet port of a contact zone;
(b) releasing bubbles into the contact zone;
(c) contacting at least a portion of the bubbles to at least a portion of the contaminants thereby forming bubble-contaminant complexes;
(d) flowing the bubble-contaminant complexes to an aggregation zone within a separation zone;
(e) removing at least some of the bubble-contaminant complexes from the aggregation zone; and
(f) withdrawing a filtered permeate through an immersed membrane filtration module from a filtration zone within the separation zone.
